(19) United States
(12) Patent Application Publication
(10) Pub. No.: US 2009/0262324 A1
(43) Pub. Date: Oct. 22, 2009

(54) ILLUMINATION OPTICS FOR PROJECTION MICROLITHOGRAPHY AND RELATED METHODS

(75) Inventors: Michael Patra, Oberkochen (DE); Markus Deguenther, Aalen (DE); Michael Layh, Aalen (DE); Johannes Wangler, Koenigsbronn (DE); Manfred Maul, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 12/464,730

(22) Filed: May 12, 2009

Related U.S. Application Data
(63) Continuation of application No. PCT/EP2007/009971, filed on Nov. 19, 2007.

(30) Foreign Application Priority Data
Nov. 21, 2006 (DE) 10 2006 054 746.2

(51) Int. Cl. G03B 27/80

(52) U.S. Cl. 355/68

(57) ABSTRACT

A microlithographic projection exposure apparatus (1) comprises an illumination system (4) with an illumination optics (5) for illuminating an illumination field in a reticle plane (6). The illumination optics (5) further includes a light distribution device (12a) which comprises a light deflection array (12) of separate elements and an optical assembly (21, 23 to 26) which converts the light intensity distribution defined by the light distribution device (12a) in a first plane (19) of the illumination optics (5) into an illumination angle distribution in the reticle plane (6). Downstream of an output coupling device (17), which is arranged in the light path between the light deflection array (12) and the reticle plane (6), a space and time resolving detection device (30) is exposed to outcoupled illumination light (31) in such a way that the detection device (30) detects a light intensity distribution corresponding to the light intensity distribution in the first plane (19). The detection device (30) allows the influence of separate elements or groups of separate elements on the light intensity distribution in the first plane (19) to be determined, particularly by varying said separate elements or groups of separate elements over time. The result is an illumination optics in which the function of the light deflection array is performed during normal operation.

The invention relates to an illumination optics for projection microlithography according to the preamble of claim 1. The invention further relates to an illumination system comprising an illumination optics of this type, a measuring and a monitoring method for an illumination optics of this type, a microlithographic projection exposure apparatus comprising an illumination optics of this type, a production method for microstructured components using a microlithographic projection exposure apparatus of this type and a microstructured component produced in accordance with this method.

An illumination optics of the type named at the outset and an illumination system using this illumination optics are disclosed in WO 2005/026 843 A2 where the illumination system is part of a microlithographic projection exposure apparatus. In the known illumination optics, a setting error of a given illumination setting is generally composed of two essential error components. On the one hand, one or more separate elements of the light deflection array may be misaligned. On the other hand, there may be systematic intrinsic drift effects of all separate elements of the light deflection array. When defining an illumination setting using the known projection exposure apparatus, the intrinsic drift effects can be kept within certain limits by permanently readjusting the separate elements which is usually done at regular intervals. A readjustment of this type is therefore also referred to as refreshing process. It is however impossible to exactly assign the systematic misalignment to individual separate elements.

It is therefore an object of the present invention to improve an illumination optics of the type named at the outset so as to permit monitoring of the setting of the light intensity distribution in the first plane of the illumination optics and therefore the function of the light deflection array in such a way that a monitoring of this type has no effect on the normal operation of the illumination optics at all or only to a very low extent.

According to the invention, this object is achieved by an illumination optics having the features set out in claim 1.

The detection device according to the invention allows the given light intensity distribution to be monitored online by means of the light deflection array without interfering with the illumination beam path of the illumination light. A deflection device, which is required in the illumination optics for the illumination light, may in particular be used as the output coupling device. A variation in light intensity distribution in the first plane of the illumination optics, which is usually a pupil plane of the illumination optics, can be reliably determined by the detection device so as to detect and correct a non-permissible deviation from a given illumination setting. The first plane of the illumination optics may in particular be a last pupil plane of the illumination optics in front of the reticle plane, in other words the plane which is exposed to an illumination light intensity that is directly associated with the illumination angle distribution in the reticle plane. In other words, the first plane of the illumination optics is not necessarily a pupil plane which is the first one to be arranged in the beam path of the illumination light in the illumination optics but usually the last pupil plane of the illumination optics in front of the reticle plane. This last pupil plane is also referred to as system pupil or system pupil plane.

An arrangement of the detection device with identical optical path lengths according to claim 2 eliminates the need for an illumination optics in the detection device as the detection device automatically makes use of the illumination light bundle formation in the first plane of the illumination optics.

A control device according to claim 3 allows the influence of individual separate elements or of given groups of separate elements of the light deflection array to be determined, which may be useful for optimizing an illumination setting to be defined.

A micromirror array according to claim 4 is a preferred embodiment of a light deflection array. A micromirror array of this type is disclosed in U.S. Pat. No. 7,061,582 B2. Alternatively, a light deflection array may also be designed as a transmissive assembly.

Capacitive actuators or piezoelectric actuators according to claim 5 ensure a fine adjustment, in particular tilting, of the separate elements of the light deflection array for precise setting of a light intensity distribution.

A read-out rate of the detection device according to claim 6 ensures a time-resolved monitoring operation.

Detection elements according to claim 7 provide for a spatial and temporal resolution which is well suitable for the monitoring operation. Detection elements of this type are in particular operable with preferably high read-out rates.

A coating according to claim 8 permits a use of silicon-based detection elements even if the wavelength of the illumination light or of the illumination radiation cannot immediately be detected by the detection element. This is for instance the case if the illumination light that is used is UV light with a wavelength of for instance 193 mm. The coating converts the illumination light into detection light with a wavelength that is detectable by the detection element.

A pixel distribution according to claim 9 results in a spatial resolution which is suitable for monitoring the pre-determined light intensity distribution. Higher pixel row and pixel column numbers which are adapted to the spatial resolution of the bundle influence on the illumination light, for instance 100 row pixels and 100 column pixels or even higher pixel numbers, are conceivable as well.

Depending on the desired monitoring quality with respect to the setting of the light intensity distribution, spatial resolutions according to claim 10 have proven to be particularly suitable.

An output coupling device according to claim 11 is particularly simple. If a semitransparent plane mirror is used, the output coupling device advantageously has no negative effect on the bundle forming of reflected and transmitted light. Advantageously, only a small fraction of the illumination light used in the projection exposure apparatus is guided to the detection device, for instance 10% or 1%. A preferred embodiment of the semitransparent mirror, in which the outcoupled wavelength is different from the useful wavelength, has the advantage that detection can be performed without requiring any useful light. Detection ideally takes place with light of a wavelength which, in terms of its distribution, is directly correlated with the light having the useful wavelength but is be effectively detectable by the detection device.

An arrangement of the detection device according to claim 12 enables the illumination angle distribution in a field plane of the illumination optics to be precisely measured.

An optical system according to claim 13 enhances the flexibility in terms of arrangement of the detection element.

An illumination optics according to claim 14 allows conclusions to be drawn with respect to an intensity distribution in the first plane of the illumination optics by means of the intensity distribution measured in the detection plane. The intensity distribution in the first plane is the result of a direct measurement of the intensity distribution in the detection plane.

A design of the optical assembly in front of the detection plane according to claim 15 avoids the necessity of post-processing the measurement result in the detection plane. This measurement result allows a direct conclusion to be drawn with respect to the light intensity distribution in the last pupil plane of the illumination optics, in other words in the system pupil plane.

An evaluation device according to claim 16 permits a quick evaluation and preferably a quick display of the measurement results of the detection device. The results may for instance be displayed using a two-dimensional color-coded diagram in which measured or detected intensities that are different from each other are displayed in different colors.

A computing module according to claim 17 allows post-processing of the measured values, for instance by scaling or normalizing.

A simulation module according to claim 18 may replace optical components which are disposed in a useful light beam path of the illumination light but not in the detection beam path towards the detection device. The simulation module may for instance store simulation values which correspond to the optical effects of individual components of the illumination optics. Simulation values of this type may for instance be obtained by means of a ray tracing program. Depending on the design of the illumination optics, the simulation values stored in the simulation module may be used to simulate the effect of the optical components of the illumination optics which are not physically provided in the detection beam path. For instance, the optical effect of a scattering disk, which is arranged in the useful light beam path but not in the detection beam path, may be simulated by a corresponding convolution of the measurement result in the detection plane. Expected residual absorptions or reflection losses or scattering losses of optical components of the illumination optics may be simulated as well. Moreover, it is possible to compensate for different image scales of a detection optics on the one hand and of an illumination optics on the other.

A signal connection according to claim 19 allows deflection positions of the separate elements such as tilt angles or translation positions to be included in the measurement result of the detection device. The evaluation unit and the control unit for the light deflection array may be integrated in a common unit.

The advantages of an illumination system according to claim 20 correspond to those which have already been explained above with reference to the illumination optics according to the invention.

Another object of the invention is to provide a measuring method for use with the illumination optics according to the invention.

This object is achieved according to the invention by a measuring method comprising the steps set out in claim 21.

This measuring method allows one to detect the influence of a separate element or of a given group of separate elements on the light intensity distribution in the first plane. If the light intensity distribution in the first plane, which is defined by the light deflection array, deviates from a desired intensity distribution, this measuring method allows one to find out which separate elements or groups of separate elements have caused this deviation. The influence thus detected can then be used to correct the deviations. The measuring method according to the invention may also be used for monitoring the light intensity distribution in the first plane of the illumination optics.

A difference calculation according to claim 22 is easy and enables the influence of the repositioned separate element(s) to be precisely determined. When doing so, it must of course be ensured that the two intensity distributions which are subtracted from each other are correctly normalized.

A calculation of desired values according to claim 23 and a comparison of desired values according to claim 24 allow the measured separate mirrors or separate mirror groups to be readjusted automatically if the contributions provided by those mirrors deviate from the desired values for setting the light intensity distribution because of drift effects, for example.

A measuring method according to claim 25 allows an automatic measurement to be performed during the operation of the illumination system.

A monitoring method according to claim 26 allows the current illumination situation in the reticle plane to be precisely detected. Depending on the result of the comparison, the illumination optics or other components of the projection exposure apparatus can then be adjusted or maintained accordingly.

The advantages of a monitoring method according to claim 27 correspond to those which have already been explained above with reference to the simulation module according to claim 18.

A monitoring method according to claim 28 in particular prevents an unwanted quality reduction of the projection result. Furthermore, this method prevents damages to optical components.

A monitoring method according to claim 29 prevents a negative influence of separate elements, which do not comply with the desired requirements, on the projection result.

A monitoring method according to claim 30 allows a given desired illumination to be optimized.

Another object of the invention is to create a microlithographic projection exposure apparatus comprising an illumination optics according to the invention or an illumination system according to the invention and to provide a microlithographic illumination method that can be performed by means of this projection exposure apparatus as well as a component that can be produced by means of this illumination method.

This object is achieved according to the invention by a microlithographic projection exposure apparatus according to claim 31, a production method according to claim 32 and a component according to claim 33.

Advantages of these objects will become apparent from the advantages described above with reference to the illumination optics and the illumination system.

An embodiment of the invention will hereinafter be explained in more detail by means of the drawing in which

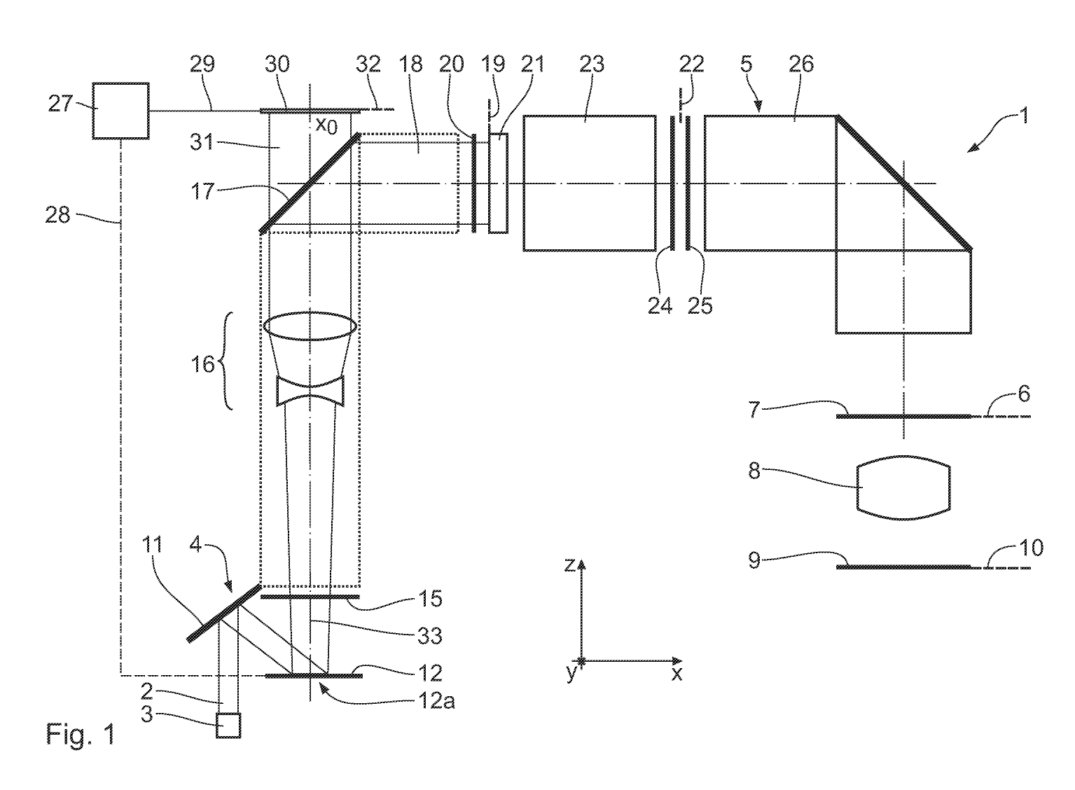

FIG. 1 is a diagrammatic meridional section through a microlithographic projection exposure apparatus comprising an illumination system with an illumination optics;

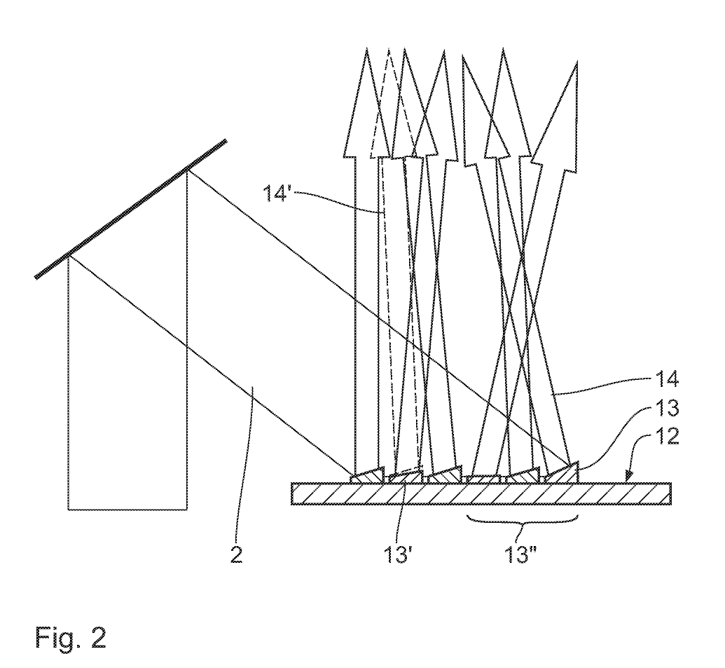

FIG. 2 is an enlarged sectional view of the illumination optics in the region of a light deflection array for defining a light intensity distribution in a first plane of the illumination optics;

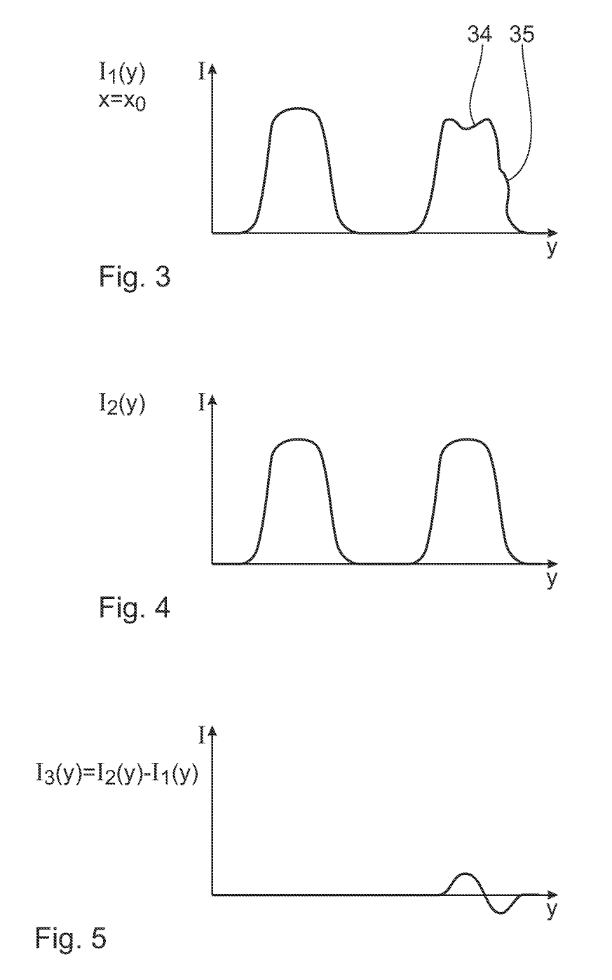

FIG. 3 is a diagrammatic view of a one-dimensional intensity distribution in a row of a detection plane of a space- and time-resolving detection device which is arranged beyond the projection light path of the illumination system and detects a light intensity distribution which corresponds to the light intensity distribution in the first plane, a separate element of the light deflection array being arranged in a first position;

FIG. 4 is a similar view to FIG. 3 of the intensity distribution measured by the row of the detection device after the separate element has been moved to a second position;

FIG. 5 shows a difference of the measured intensity distributions according to FIGS. 4 and 3;

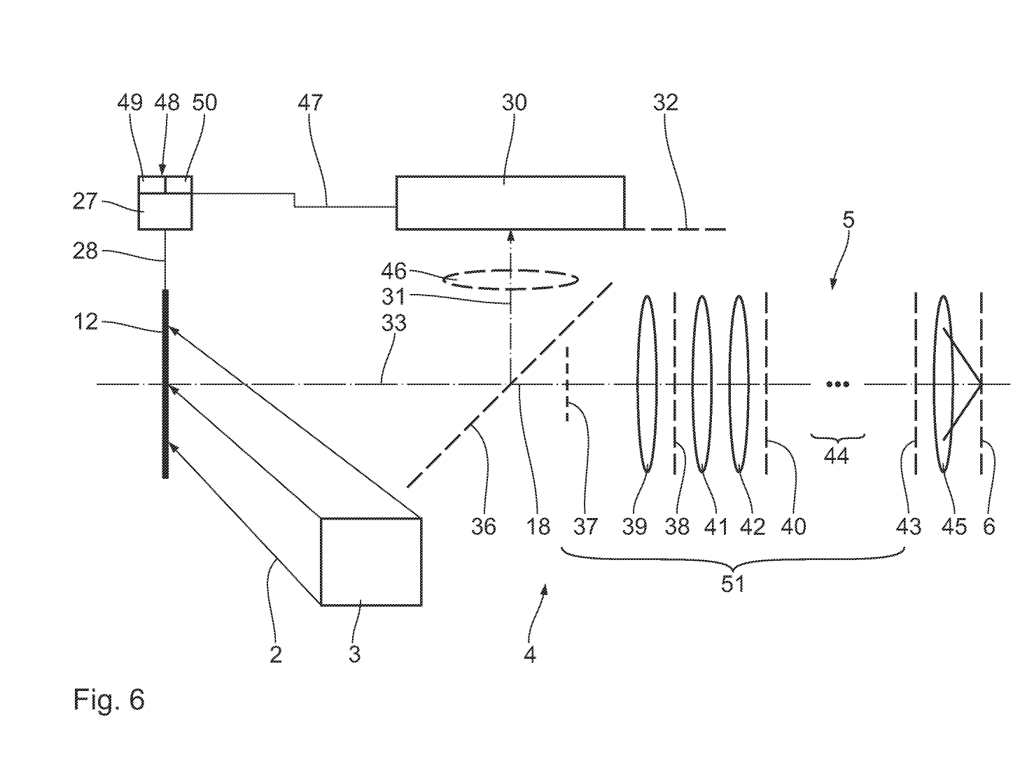

FIG. 6 is a diagrammatic meridional section through an alternative illumination system of a microlithographic projection exposure apparatus comprising an illumination optics and an alternative embodiment of a detection device;

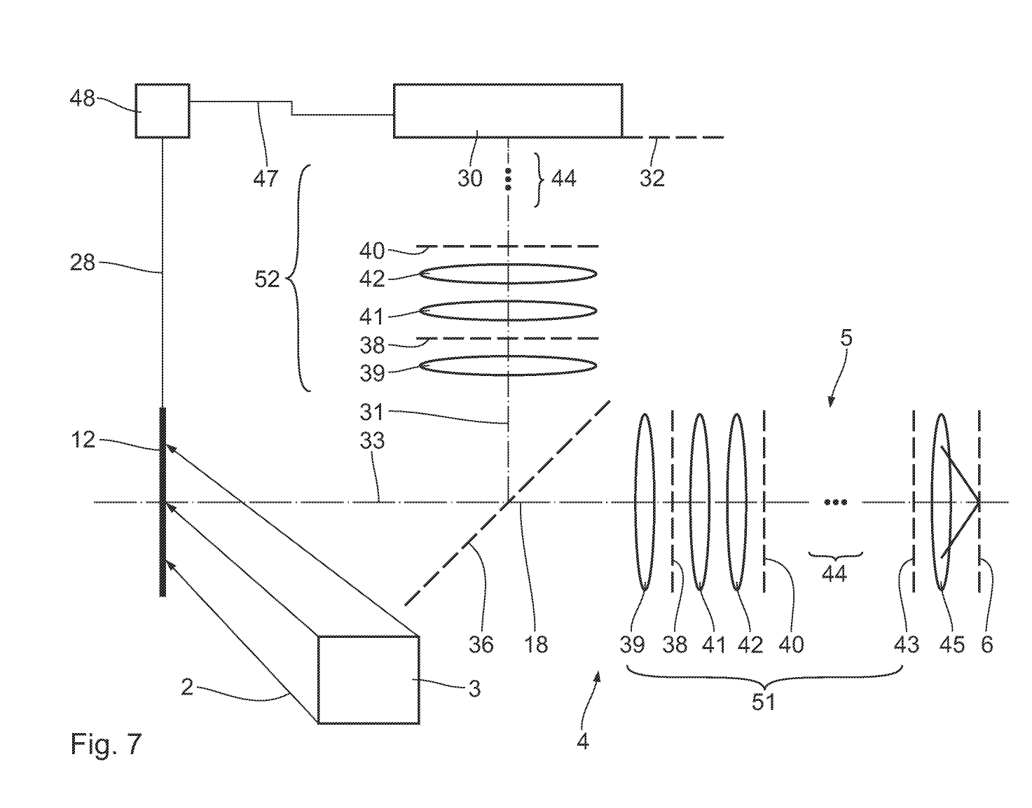

FIG. 7 shows the illumination system according to FIG. 6 comprising another embodiment of a detection device;

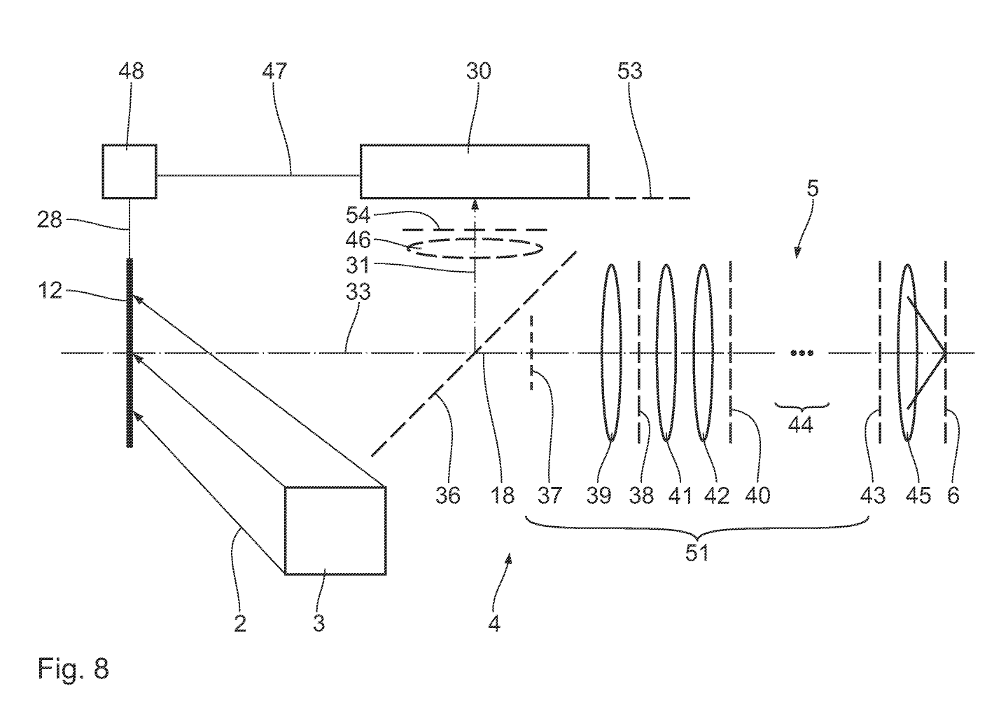

FIG. 8 shows the illumination system according to FIG. 6 comprising another embodiment of a detection device; and

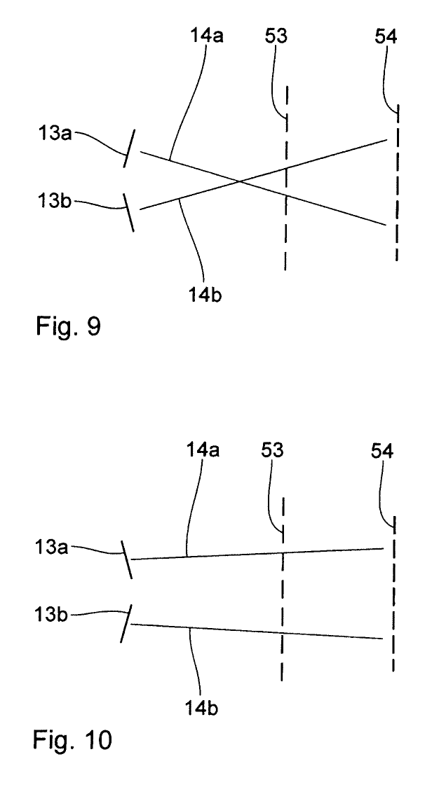

FIGS. 9 and 10 are diagrammatic views of the influence of two separate elements of a light deflection array of the illumination optics of the illumination system according to FIGS. 6 to 8 in a detection plane of the detection device according to FIG. 8.

FIG. 1 is a diagrammatic view of a microlithographic projection exposure apparatus 1. Illumination light 2 is generated by a light source or radiation source 3. The light source 3 is for instance an excimer laser which generates the illumination or projection light 2 with a wavelength of 193 nm. When emitted by the light source 3, the illumination light 2 has a rectangular bundle cross-section of 20 mm×20 mm when seen perpendicular to the beam direction and a divergence of approximately 1 mrad. An illumination system 4 of the projection exposure apparatus 1 comprises the light source 3, a light bundle provision unit which guides the illumination light 2 from the light source 3 to the entrance into the illumination setting 4, and an illumination optics 5. Said illumination optics 5 is used to form the illumination light 2 in such a way that a reticle 7 in an illumination field of a reticle plane or mask plane 6 is exposed to light with a given illumination angle distribution. A projection optics 8 images the illumination field in the reticle plane 6 onto a wafer 9 in a wafer plane 10. The wafer 9 is provided with a light- or radiation-sensitive layer which is influenced by the defined illumination by means of the illumination light 2 in such a way that a microstructure on the reticle 7 is projected onto the wafer 9 at a given image scale which is defined by the projection optics 8; this is used for producing microstructured components.

Starting from the light source 3, the illumination light 2 is at first deflected in the direction of a light deflection array in the form of a micromirror array 12 by means of the bundle provision unit which is in this example depicted by a deflection mirror 11. The micromirror array 12 and the deflection mirror 11 are shown in an enlarged cross-sectional view in FIG. 2. A micromirror array 12 of this type is described in U.S. Pat. No. 7,061,582 B2. The micromirror array 12 is part of a light distribution device 12a of the illumination optics 5. The micromirror array 12 comprises a plurality of separate elements, i.e. separate mirrors 13 in the example of the micromirror array 12, which are arranged in rows and columns. The micromirror array 12 has several thousands of separate mirrors 13. Numbers of separate mirrors between 4000 and 80000, for instance 4000, 16000, 40000 or 80000 separate mirrors 13, are preferred. A smaller number of separate mirrors 13 is conceivable as well, for instance less than 1000 separate mirrors 13. There may for instance be provided between 100 and 1000000 separate mirrors 13. The mirror dimensions (aperture) of the separate mirrors 13 amount to 60 μm×60 μm. Other apertures, for instance 100 μm×100 μm or even in the millimeter range, are conceivable as well. A number of 100000, 200000 or 300000 separate mirrors 13 is conceivable as well. Each separate mirror 13 is individually allocated to a capacitive actuator or a piezoelectric actuator (not shown). The actuator allows a tilt angle of the separate mirror 13, and therefore the deflection of the illumination light 2 to be defined when impinging upon this separate mirror 13. Each separate mirror 13 is provided with two independent actuators for tilting the separate mirror 13 about two tilt axes which are perpendicular to each other in order to adjust an angle of the respective separate mirror 13 freely in space. The illumination light 2 is thus divided by the micromirror array 12 into a number of separate illumination light beams 14 corresponding to the number of separate mirror 13 which are exposed to the light beams 14. The divergence of the separate illumination light beams 14 is smaller than 6 mrad.

In a direction perpendicular to the deflected illumination light 2, the micromirror array 2 has an extension of for instance 21 mm×21 mm. Other extensions of for instance 38 mm×38 mm or 55 mm×55 mm are conceivable as well. A maximum deflection angle variation which is achievable by means of the separate mirrors 13 amounts to between 2° and 10°. Between the extreme deflection positions of a separate mirror 13, in other words between the minimum and the maximum deflection position thereof, a plurality of intermediate deflection positions are achievable. For instance, 1000 to 2000 intermediate deflection positions are conceivable which are adjustable in a defined way by means of the capacitance of the capacitive actuator which is allocated to the respective separate mirror 13.

Downstream of the micromirror array 12, the illumination light 2 passes through a polarization influencing element 15 which allows the illumination light 2 to be depolarized. When using other polarization elements, the polarization direction of the illumination light 2 may also be rotated through a given angle, for instance through 90°, or to set alternative polarization modes.

Downstream of the polarization influencing element 15, the illumination light 2 passes through an optics 16 with a focal length f (Fourier lens) before impinging upon an output coupling device in the form of a semitransparent mirror 17. The expansion optics 16 has a focal length which is greater than 250 mm. The focal length of the optics 16 is in particular between 850 and 1200 mm. The main portion of the illumination light 2, usually more than 90%, for instance 99%, in other words the main illumination light portion 18, is deflected through 90° by the semitransparent mirror 17. In the region of a first plane 19 of the illumination optics 5, which corresponds to a pupil plane of the system or a plane which is conjugated to the pupil plane of the system, the main illumination light portion 18 initially passes through PS elements 20 and then through a field defining element (FDE) 21 comprising two diffusers. A spot, which is generated by each separate mirror 13 of the micromirror array 12 in the plane 19 is much smaller than the entire light distribution in the plane 19 which is the result of a superposition of the contributions of all separate mirrors 13. The FDE 21 is an optical array element which divides the main illumination light portion 18 passing therethrough into individual channels. At the same time, the FDE 21 generates a numerical aperture across the cross-section of the main illumination light portion 18 which will be used by the subsequent illumination system for generating the shape of the illumination field in the reticle plane 6. The FDE 21 is configured in the manner of a honeycomb condenser. The individual FDE channels 21, in other words the honeycombs, have an extension of 0.5 mm×0.5 mm in the plane perpendicular to the beam direction of the main illumination light portion 18. The FDE has a diameter of approximately 125 mm.

A field lens group 23 guides bundles of the main illumination light portion 18 from the FDE 21 to a field plane 22 of the illumination optics 5 which is optically conjugated to the reticle plane 6. In the region of the field plane 22, the main illumination light portion 18 initially passes through a setting device 24 which is used to define and in particular homogenize an illumination dose of the main illumination light portion 18 impinging upon the light-sensitive layer of the wafer 9. An example of the setting device 24 is described in the disclosure WO 2005/040 927 A2 of the applicant which claims benefit of the associated application DE 103 48 513.9. Having passed through the setting device 24, which is also referred to as Unicom, the main illumination light portion 18 passes through a reticle masking system (REMA) 25. A REMA objective 26, which is folded through 90°, images the field plane 22 into the reticle plane 6.

FIG. 1 also shows a Cartesian xyz coordinate system. The x-direction extends to the right of FIG. 1. The y-direction extends into the drawing plane in a direction perpendicular to the drawing plane, and the z-direction extends upwardly in FIG. 1.

The projection exposure apparatus 1 is configured in the manner of a scanner. The scanning directions of the reticle 7 on the one hand and of the wafer 9 on the other are parallel to the y-axis.

The micromirror array 12 is used to define a light intensity distribution of the illumination light 2 in the pupil plane 19. This light intensity distribution in the pupil plane 19 corresponds to an illumination angle distribution in the reticle plane 6. The illumination angle distribution to be selected, the so-called illumination setting, is set via a central control device 27 of the projection exposure apparatus 1. To this end, the control device is connected to the micromirror array 12 via a signal line 28 which is shown by a dashed line in FIG. 1. The selected illumination setting may for instance be a conventional setting, an annular setting or a dipole or multipole setting.

The control device 27 not only enables one to define a particular illumination setting but also to monitor the respectively defined illumination setting in order to make sure that an actual illumination setting, which is realized by the illumination system 4, actually corresponds to the desired setting that has been defined. To this end, the control device 27 is connected to a space and time resolving detection device 30 via a signal line 29. Said detection device 30 is arranged in the light path of the illumination light detection portion 31, which is able to pass through the semitransparent mirror 17, so as to be impinged by the illumination light detection portion 31 in such a way this illumination light detection portion 31 is detected across its entire cross-section. The illumination light detection portion 31 is adapted to the size of a detection element of the detection device 30 by means of an optical adaptation unit (not shown). An optical path length between a detection plane 32 of the detection device 30 and the semitransparent mirror 17 on the one hand may be identical to an optical path length between the output coupling device 17 and the pupil plane 19 on the other. A situation of this type is shown in FIG. 1. The embodiment comprising the optical adaptation unit and the embodiment with the adapted optical path length both ensure that the detection device 30 detects a light intensity distribution in the detection plane 32 which corresponds to the light intensity distribution in the pupil plane 19. Alternatively, the detection device 30 may be arranged in such a way that the detection plane 32 thereof is disposed in the illumination light detection portion 31 in a plane which is optically conjugated to the pupil plane 19. Also in this case, the detection device 30 is able to detect a light intensity distribution of the illumination light detection portion 31 which corresponds to the light intensity distribution of the main illumination light portion 18.

The optically sensitive detection element of the detection device 30 is a CCD chip or a CMOS sensor. The detection element has at least 20 row pixels and at least 20 column pixels. A spatial resolution of the detection element amounts to 50 μm. Other spatial resolutions are conceivable as well, depending on the degree of exactness required when monitoring the light intensity distribution in the detection plane 32 for monitoring the light intensity distribution in the pupil plane 19. Spatial resolutions which are much less sensitive, for instance between 50 μm and 500 μm or in the millimeter range, are conceivable as well, for instance a spatial resolution of 5 mm. The spatial resolution should correspond to or be smaller than the order of magnitude of the spot generated in the plane 19 by the separate elements 13 of the micromirror array 12. The detection device 30 has a readout rate of the detection element which is greater than 100 Hz, in particular greater than 1 kHz.

The detection element is provided with a UV conversion coating in the form of a fluorescent substance so as to improve the sensitivity of the detection element with respect to the wavelength of the illumination light 2, the UV conversion coating being stimulated by the incident illumination light 2 to emit light in a wavelength range which is detectable by the detection element.

The following is a description, by the example of a capacitively controlled micromirror array 12 taken in conjunction with FIGS. 3 to 5, of a measuring method for determining the influence of a separate mirror or separate element 13 on the light intensity distribution in the pupil plane 19 of the illumination optics 5.

The intensity distribution generated in the detection plane 32 is measured in a first measuring cycle, with the micromirror array 12 being in a configuration in which the separate element to be measured, for instance the separate element 13′ which is the second separate mirror 13 from left according to FIG. 2, is in a first position. Said first position may for instance be a position just before refreshing the capacitance of the capacitive actuator of the separate mirror 13. FIG. 3 shows an example of the intensity distribution I₁ measured in this first measuring step. In this example, an intensity distribution I₁ is shown one-dimensionally in dependence on the y-direction in the detection plane 32, in other words a pixel column of the detector element of the detection device 30, namely the central pixel column of the detection element in the plane x=x₀ containing an optical axis 33 of the illumination optics 5. The measurement result I₁(y) with two peaks corresponds to a section through an annular setting. A similar measurement result is also obtained in the case of a y-dipole or a multipole illumination setting which is arranged correspondingly. Naturally, all pixel columns of the detection device 30 are read out to obtain additional pixel column information which allows one to distinguish between the various illumination settings.

As soon as the intensity distribution I₁ has been measured and read out, the separate element 13′ to be measured is repositioned from the first position into a second position shown by dashed lines in FIG. 2. This repositioning is the result of the refreshed capacitance of the capacitive actuator of the separate mirror 13′. During the refreshing process, an actual capacitance of the associated actuator is adapted to a desired capacitance defined by the control device 27. This repositioning is shown by strongly exaggerated dashed lines in FIG. 2; in reality, the influence of the refreshing process on the tilt angle of the separate element 13′ is less pronounced so it would not have been visible otherwise. The repositioning of the separate mirror 13′ leads to a change in direction of the separate illumination light beam 14′, which is shown dashed in FIG. 2 and is deflected by said separate mirror 13′, in accordance with the repositioned tilt angle. This change in direction of the separate illumination light beam 14′ is also shown in a greatly exaggerated view in FIG. 2.

When the repositioning is complete, an intensity distribution I₂ in the detection plane 32 is again measured by means of the detection device 30. FIG. 4 shows a sectional view of the result of this measurement which corresponds to the illustration of FIG. 3. FIG. 4 again shows the intensity along the central pixel column (I₂(y) at x=x₀). As can be seen, the repositioning of the separate mirror 13′ has eliminated a dip 34 in the right-hand peak of the intensity distribution according to FIGS. 3 and 4. Likewise, an excess intensity 35 which, in the measurement result according to FIG. 3, had been present in the right-hand flank of the right-hand peak of the intensity distribution I(y) according to FIGS. 3 and 4, has now been eliminated so that the shape of the right-hand peak of FIG. 4 exactly corresponds to the shape of the left-hand peak, which results in a symmetric setting corresponding to a desired value.

The intensity distribution I₂ measured in the detection plane 32 is read out as well. Afterwards, the influence of the separate mirror 13′ to be measured is determined from the two measurement results I₁ and I₂ by taking the difference between the two intensity measurement results I₁ and I₂. A difference I₃(y)=I₂(y)−I₁(y) of this type is shown in FIG. 5 for the two measurement results I₂(y) and I₁(y) according to FIGS. 3 and 4. This difference clearly shows that due to the repositioning, the contribution of the separate mirror 13′ to be measured has moved from a position at the right-hand flank of the right-hand peak to the center of the right-hand peak. Thus, the repositioning-dependent influence of the separate mirror 13′ to be measured has been exactly determined.

The sensitivity of the measuring process is in particular due to the fact that the limited spot size of the separate illumination light beam 14 of a separate mirror 13, which impinges upon the detection element of the detection device 30, limits the number of separate mirrors 13 which are able to contribute to the intensity measured at a particular location of the detection element. As the contributing separate mirrors 13 are usually disposed at a considerable spatial distance from each other, they can be discriminated from each other and allocated with respect to their respective influence on the detected measuring value by means of the temporal resolution of the detection element. The approximate number of the separate mirrors 13 contributing to the measurement result at a detection location is obtained from the relationship between the total number of separate mirrors 13 of the micromirror array 12 and the number of the pixels of the space-resolving detection element.

The influence thus determined of the separate mirror 13′ to be measured may now be used to determine a desired positional value for the separate mirror 13′ to be measured which is then compared to a desired positional value that is currently stored in the control device 27. The desired positional value calculated from the measurement results is the value where an intensity distribution in the position plane 32 and therefore in the pupil plane 19 deviates the least from a desired intensity distribution. This desired positional value calculated from the measurement may deviate from the desired positional value which is stored in the control device for the separate mirror 13′ to be measured due to drift effects. When this deviation is determined by means of the above-described intensity measurement and repositioning of the separate mirror 13′ to be measured, a new desired value may be set by means of the control device 27 to ensure that the illumination setting, which is currently realized using the illumination system 4, corresponds to the given illumination setting in the best possible way. As a result, the illumination setting is exactly defined and also takes into account inevitable drift effects, for instance thermal drifts of the light source 3 or the illumination optics 5 or capacitive drifts of the actuators of the micromirror array 12. In the described example, the refreshing process serves to identify the contribution of a separate mirror 13 by way of a temporal discrimination. If the light deflection device, in other words the micromirror array 12, does not require a refreshing process, the position of the separate mirrors 13 may be determined and corrected by a defined variation of the actuators.

Instead of repositioning an individual separate mirror 13′ to be measured, it is conceivable as well for a given group 13″ of separate mirrors to be repositioned between the measurements for which intensity examples are presented in FIGS. 3 and 4. A group 13″ of this type is shown by way of example in FIG. 2. The group is in particular the group which requires the next refreshment due to a necessary refreshment cycle of the associated capacitive actuators. This allows the measurement of the separate mirror contributions to the light intensity distribution defined in the pupil plane 19 to take place online during normal operation of the projection exposure apparatus 1. The read-out rate of the detection device 30 then corresponds to the refreshment rate of the micromirror array 12. If the refreshment rate corresponds to the repetition rate of the light source 3, which is usually in the kHz range, then the detection device 30 has a read-out rate which is in the kHz range as well and is therefore synchronized with the refreshment rate. The kHz read-out rate results in a corresponding temporal resolution of the detection device 30 in the ms range.

As an alternative to a refreshment repositioning, a separate mirror contribution or a contribution of a given group of separate mirrors of the micromirror array 12 may also be determined by repositioning the separate mirrors to be measured in such a way that before or after the repositioning, their contribution to the intensity in the detection plane 32 equals zero. This may improve the measuring accuracy in those cases where the influence of the separate mirrors to be measured deviates from a desired value only to a very slight degree.

FIG. 6 shows another embodiment of an illumination system of a microlithographic projection exposure apparatus. Components of this illumination system which correspond to those that have already been explained above with reference to FIGS. 1 to 5 have the same reference numerals and are not discussed in detail again.

FIG. 6 only shows the components of a projection exposure apparatus which are part of the illumination system 4. In other words, the light path of the illumination light 2 is shown from the light source 3 to the reticle plane 6.

The illumination optics 5 is only represented in FIG. 6 by the micromirror array 12 and by some optical components in the form of lenses which are illustrated diagrammatically. It is clear that the illumination optics 5 of the embodiment according to FIG. 6 may also be a catadioptric or catopric optics.

A 45° output coupling mirror 36 is arranged downstream of the micromirror array 12 in the beam path of the illumination light 2. The output coupling mirror 36 is another example of an output coupling device. The function of the output coupling mirror 36 corresponds to that of the semitransparent mirror 17 of the embodiment according to FIGS. 1 to 5. The detection portion 31 is coupled out of the incident illumination light 2 by the output coupling mirror 36 through 90° relative to the optical axis 33. The main illumination light portion 18 passes through the output coupling mirror 36. The intensity ratio between the detection portion 31 and the main portion 18 of the illumination light 2 may amount to 0.1%, 1%, 2% or even 10%. Advantageously, less than 5% of the illumination light 2 is coupled out. In the beam path of the main illumination light portion 18, a scattering disk 37 may be the first element downstream of the output coupling mirror 36. As not all embodiments of the illumination optics 5 according to FIG. 6 are provided with a scattering disk of this type, the scattering disk 37 is shown dashed in FIG. 6. An optical component 39, which is in the form of a lens, is arranged in the subsequent beam path in front of a first pupil plane 38 of the illumination optics 5. Two additional optical components 41, 42, which are also in the form of lenses, are arranged between the first pupil plane 38 and a downstream second pupil plane 40 of the illumination optics 5 according to FIG. 6. A transmission optics 44, which is only indicated in FIG. 6, is arranged upstream of the reticle plane 6 between the second pupil plane 40 and a last pupil plane 43 of the illumination optics 5 according to FIG. 6. Another transmission optics between the last pupil plane 43 and the reticle plane 6 is represented in FIG. 6 by an optical component 45 which is also in the form of a lens.

An illumination angle distribution of the illumination light 2 in the reticle plane 6 is directly correlated with an intensity distribution of the illumination light 2 in the last pupil plane 43. The last pupil plane 43 is therefore also referred to as system pupil or system pupil plane.

The detection plane 30 is arranged in the detection plane 32 of the embodiment according to FIG. 6. In the embodiment according to FIG. 6, an optical assembly 46 may be arranged between the output coupling mirror 36 and the detection device 30 which optical assembly 46 is designed in the same way as an optical assembly between the output coupling mirror 36 and the first pupil plane 38. This is indicated in FIG. 6 by a dashed optical component 46 in the illumination light detection portion 31 between the output coupling mirror 36 and the detection device 30. The detection device 30 is arranged at such a distance from the output coupling mirror 36 that the detection plane 32 corresponds to the first pupil plane 38. The detection device 30 in the detection plane 32 can therefore be used to measure the intensity distribution of the illumination light 12 in the first pupil plane 38 which provides direct information with respect to the illumination angle distribution in the reticle plane 6.

An evaluation device 48 is connected to the detection device 30 via a signal line 47 for evaluation of measurement results of the detection device 30. The evaluation device 48 is integrated with the control device 27 to form an electronic unit. The evaluation unit 48 further includes a computing module 49 for post-processing of the measurement results of the detection device 30 and a simulation module 50. The simulation module 50 serves to perform at least a partial simulation of an optical assembly 51 comprising the optical components 37, 39, 41, 42, 44 between the output coupling mirror 36 and the lasts pupil plane 43. By taking into account the optical effects of the optical components of the illumination optics 5, which are arranged downstream of the first pupil plane 38, the measurement result of the detection device 30 in the detection plane 32 may provide even more information with respect to the illumination angle distribution in the reticle plane 6, as will be explained below:

In the case indicated in FIG. 6 by the dashed optical component 46, where the optics between the output coupling mirror 36 and the detection device 30 corresponds to the illumination optics 5 between the output coupling mirror 36 and the first pupil plane 38, if necessary by installing a scattering disk (not shown in FIG. 6), which corresponds to the scattering disk 37, between the output coupling mirror 36 and the optical component 46, it is sufficient if the simulation module 51 simulates the illumination optics 5 between the first pupil plane 38 and the last pupil plane 43. This may for instance take place by determining a transmission function of the intensity distribution from the first pupil plane 38 to the last pupil plane 43 by means of a calibration measurement, with the measurement result of the detection device 30 being post-processed in the simulation module 50 with respect to this transmission function. In other words, the simulation module 50 performs a computed simulation of the optical effect of the optical components 41, 42 on the one hand and of the transmission optics 44 on the other.

Within the evaluation device 48, the computing module 49 on the one hand and the simulation module 50 on the other can but need not be in signal connection with the control device 27.

The light intensity distribution in the first pupil plane 38 of the illumination optics 5 is monitored as follows: during the operation of the illumination system 4, the detection device 30 measures the intensity distribution in the detection plane 32. Afterwards, the actual light intensity distribution thus determined, i.e. in this case measured, is compared to a given desired light intensity distribution. If this comparison between actual light intensity distribution and desired intensity distribution shows that these light intensity distributions differ from each other by more than a given tolerance value, the operation of the projection exposure apparatus, which includes the illumination system 4 according to FIG. 6, is interrupted. The tolerance value and the desired light intensity distribution are stored in a memory of the evaluation device 48.

Instead of comparing the measured actual light intensity distribution directly with the desired light intensity distribution, the measured actual light intensity distribution may also be converted into a determined actual light intensity distribution which is then compared to a given desired light intensity distribution. The determined actual light intensity distribution may for instance be obtained by conversion of the measured intensity distribution in the simulation module 50 using simulation values. To this end, simulation values are stored in the simulation module 50 which for instance correspond to the optical effect of the optical components 41, 42 and 44. Simulation values of this type may for instance be obtained by means of a ray tracing program.

The determined actual light intensity distribution may furthermore be obtained by conversion of the measured intensity distribution by means of an alternative or additional post-processing function provided by the simulation module 50. The effect of the optional scattering disk 37 may for instance be reproduced by a mathematical convolution of the measured light intensity distribution with a convolution kernel reproducing the scattering disk. The actual light intensity distribution thus determined is then compared to a desired light intensity distribution in the last pupil plane 43.

As explained above with reference to the embodiment according to FIGS. 1 to 5, the detection device 30 may also be used in the embodiment according to FIG. 6 to determine the influence of a separate mirror of the micromirror array 12. During the monitoring process, separate elements of the micromirror array of the embodiment according to FIG. 6 are no longer used for generating the light intensity distribution for instance in the first pupil plane 38 if their determined influence differs from a desired influence by more than a given tolerance value. Likewise, the tolerance value of the respective separate elements is stored in a memory of the evaluation device 48.

During the monitoring process, an impingement through separate mirrors of the micromirror array 12, whose determined influence differs from the desired influence by more than the given tolerance value, may be replaced by an impingement through other separate elements whose influence differs from the desired influence by no more than the given tolerance value. During the monitoring process, one can for instance discover that certain separate mirrors have a lower reflectivity than other separate mirrors. At those points where there must be a high light intensity in the last pupil plane 43, it must be ensured that this high light intensity is generated by an impingement through separate mirrors of the micromirror array 12 having a high reflectivity. If the reflectivity of some of the separate mirrors used for this purpose decreases, for example, the evaluation device 48 may initiate a rearrangement of the separate mirrors which are responsible for generating the light intensity distribution in the last pupil plane 43 in such a way that these separate mirrors with lower reflectivity are replaced by other separate mirrors with higher reflectivity. To this end, the evaluation device 48 is in signal connection with the control device 27 for actuating the micromirror array 12.

FIG. 7 shows another embodiment of an illumination system 4 for a microlithographic projection exposure apparatus. Components which correspond to those that have already been explained above with reference to FIGS. 1 to 6 have the same reference numerals and are not discussed in detail again.

In the embodiment according to FIG. 7, an exact duplicate of the optical assembly 51 of the illumination optics 5 is provided between the output coupling mirror 36 and the last pupil plane 43. This duplicate is hereinafter referred to as duplicate assembly 52. The duplicate assembly 52 is arranged between the output coupling mirror 36 and the detection device 30. In contrast to the embodiment according to FIG. 6, the optional scattering disk 37 is dispensed with in the optical assembly 51 according to FIG. 7. Consequently, the duplicate assembly 52 is then not provided with any such scattering disk either. The distance of the individual optical components of the duplicate assembly 52 from one another and from the output coupling mirror 36 corresponds to the respective distances of the optical assembly 51. The intensity distribution of the illumination light in the illumination light detection portion 31 is therefore exactly identical to the intensity distribution of the main illumination light portion 18 in the last pupil plane 43. This allows the intensity distribution of the illumination light 2 in the last pupil plane 43, in other words in the system pupil, to be measured and monitored by means of the detection device 30 without requiring a conversion or a component simulation for determining an actual light intensity distribution for comparison with a desired light intensity distribution. A simulation module is therefore not required in the embodiment according to FIG. 7.

FIG. 8 shows another embodiment of an illumination system 4 of a microlithographic projection exposure apparatus. Components which correspond to those that have already been explained above with reference to FIGS. 1 to 7 have the same reference numerals and are not discussed in detail again.

In contrast to the embodiment according to FIG. 6, a detection plane 53 of the detection device 30 in the embodiment according to FIG. 8 is arranged at a greater distance from the output coupling mirror 36 than the detection plane 32 in the embodiment according to FIG. 6. The detection plane 53 is therefore spaced from a pupil plane 54 in the beam path of the illumination light detection portion 31, which pupil plane 54 corresponds to the first pupil plane 38 in the beam path of the main illumination light portion 18. The detection plane 53 is arranged between a pupil plane and a field plane in the beam path of the illumination light detection portion 31.

Without further information, the measurement result obtained by means of the detection device 30 in the detection plane 53 is not sufficient for a conclusion to be drawn with respect to the intensity distribution in the system pupil plane 43. This will hereinafter be illustrated by means of FIGS. 9 and 10 which show separate illumination light beams 14a, 14b at various positional angles of two separate mirrors 13a, 13b of the micromirror array 12 of the embodiment according to FIG. 8. The illustrations of FIGS. 9 and 10 do not show how the separate illumination light beams are folded by way of the output coupling mirror. At this position of the separate mirrors 13a, 13b, the separate illumination light beams 14a, 14b intersect in front of the detection plane 53. At the position of the separate mirrors 13a, 13b according to FIG. 10, the separate illumination light beams 14a, 14b do not intersect.

The distance of the points of incidence of the separate illumination light beams 14a, 14b on a pupil plane 54, which is arranged downstream of the detection plane 53 and is optically conjugated to the system pupil plane 43, is identical in both configurations of the separate mirrors 13a, 13b according to FIGS. 9 and 10. Depending on whether the separate mirrors 13a, 13b are positioned according to FIG. 9 on the one hand or FIG. 10 on the other, however, the distance of the separate illumination light beams 14a, 14b from each other is different in the region of the detection plane 53. Although the detection device 30 therefore provides different measurement results in the detection plane 53, the same intensity distribution may be obtained in the pupil plane 54 by means of the separate illumination light beams 14a, 14b if the intensities of the separate rays 14a, 14b are identical. In order to obtain the intensity distribution in the pupil plane 54 from the measurement in the detection plane 53 for determining a measure for the intensity distribution of the illumination light 2 in the system pupil plane 43, the detection device 30 according to FIG. 8 requires additional information about the position of the respective separate mirrors 13, i.e. for instance the separate mirrors 13a and 13b. As soon as this information about the mirror positions is available, the detection device 30 according to FIG. 8 is able to determine the intensity distribution in the pupil plane 54, and therefore in the system pupil plane 43 as well, from the measurement result obtained in the detection plane 53.

1. An optical system, comprising:
a light distribution device comprising a light deflection array comprising spatially distributed separate elements configured to generate a light intensity distribution in a first plane;
an output coupling device;
an optical assembly configured to convert the light intensity distribution in the first plane into an illumination angle distribution in a second plane; and
a detection device downstream of the output coupling device along a light path between the light deflection array and the second plane so that the detection device is exposed to light that is outcoupled by the output coupling device,
wherein the detection device comprises a space and time resolving detection device, the detection device is configured to detect a light intensity distribution corresponding to the light intensity distribution in the first plane, and the optical system is an illumination system configured to be used in a microlithography projection exposure apparatus.

2. An optical system according to claim 1, wherein:
an optical path length between the output coupling device and a third plane is identical to an optical path length between the output coupling device and a fourth plane;
the detection device is disposed in the third plane; and
the fourth plane is the same is the first plane or is optically conjugated to the first plane.

3. An optical system according to claim 1, further comprising actuators and a control device configured to interact with the actuators to move at least some of the separate elements of the light deflection array.

4. An optical system according to claim 1, wherein the light deflection array comprises a micromirror array.

5. An optical system according to claim 1, further comprising actuators configured to interact with the separate elements of the light deflection array, the actuators being selected from the group consisting of capacitive actuators, piezoelectric actuators and combinations thereof.

6. An optical system according to claim 1, wherein the detection device has a read-out rate which is greater than 100 Hz.

7. An optical system according to claim 6, wherein the read-out rate of the detection device is greater than 1 kHz.

8. An optical system according to claim 1, wherein the detection device comprises a detection element comprising an element selected from the group consisting of a CCD chip and a CMOS sensor.

9. An optical system according to claim 8, wherein the detection element comprises a coating which can convert incident light into detection light with a wavelength that is detectable by the detection element.

10. An optical system according to claim 1, wherein the detection element comprises at least 20 row pixels and at least 20 column pixels.

11. An optical system according to claim 1, wherein the detection device has a spatial resolution of no more than 5 mm.

12. An optical system according to claim 11, wherein the detection device has a spatial resolution of 50 μm.

13. An optical system according to claim 1, wherein the output coupling device comprises a partially transparent mirror.

14. An optical system according to claim 13, wherein the partially transparent mirror is configured so that the outcoupled light has a wavelength that is not identical to a useful wavelength for illumination of an illumination field of the optical system.

15. An optical system according to claim 1, wherein the detection device is disposed in a plane that is optically conjugated to a pupil plane of the optical system.

16. An optical system according to claim 1, further comprising an optical adaptation unit upstream of the detection device and configured to adapt a bundle cross-section of the outcoupled light to a size of a detection element of the detection device.

17. An optical system according to claim 1, further comprising an additional optical assembly an optical assembly between the output coupling device and a third plane in which the detection device is located, the additional output coupling device having a design that is identical to a design of the optical assembly between the output coupling device and a first pupil plane of the optical system.

18. An optical system according to claim 1, further comprising an additional optical assembly between the output coupling device and a third plane in which the detection device is located, the additional optical assembly having a design that is identical to a design of the optical assembly between the output coupling device and a last pupil plane of the illumination optics.

19. An optical system according to claim 1, further comprising an evaluation device in signal connection with the detection device.

20. An optical system according to claim 19, wherein the evaluation device comprises a computing module for post-processing of the measurement results.

21. An optical system according to claim 19, wherein the evaluation device comprises a simulation module for the at least partial simulation of an optical assembly between the output coupling device and a last pupil plane of the optical system.

22. An optical system according to claim 19, further comprising actuators and a control device configured to interact with the actuators to move at least some of the separate elements of the light deflection array, wherein the evaluation device is in signal connection with the control device.

23. A system, comprising:
a light source; and
an optical system according to claim 1.

24. A system, comprising:
an optical system according to claim 1; and
projection optics,
wherein the system is a microlithography projection exposure apparatus.

25.-40. (canceled)
